(19) United States
(12) Patent Application Publication
(10) Pub. No.: US 2011/0270572 A1
(43) Pub. Date: Nov. 3, 2011

(54) METHOD AND APPARATUS FOR CALCULATING THE DENSITY OF CONCRETE BLOCKS

(76) Inventor: Stephen SCHOONOVER, Waynesboro, PA (US)

(21) Appl. No.: 13/097,737

(22) Filed: Apr. 29, 2011

Related U.S. Application Data
(60) Provisional application No. 61/329,642, filed on Apr. 30, 2010.

(51) Int. Cl. G06F 19/00

(52) U.S. Cl. 702/156

(57) ABSTRACT

A device for calculating the density of blocks includes a block manufacturing machine. In the block manufacturing machine, blocks are formed on a pallet. The weight of the empty pallet is known and the weight of the pallet after being loaded with blocks is measured. The length and width of each block is known form the block mold. However, the height of each block is measure, preferably by a laser height measuring station. From the known quantities, the volume and total weight of the blocks on the pallet are known. From these measurements, the density can be calculated to ensure that a minimum density of the blocks is maintained.

### FIELD OF THE INVENTION

The invention relates to a method and apparatus for the continuous monitoring of concrete density during the production of molded concrete products, in particular pavers or wall blocks.

### BACKGROUND OF THE INVENTION

The number of blocks produced on a pallet is subject to the mold design, and can be from one to many. In the production of blocks, it is important for dimensions and minimum density to be maintained. The density is critical to the compressive strength of concrete.

The width and length dimensions of blocks are based on the internal measurements of the mold, and are fixed. The height of the blocks is determined by many parameters including the amount of fill of the concrete into the mold, the amount and length of time of mold vibration and the amount and length of tamping compaction of the mold. Variations of these parameters are under the control of the mold machine operator. The operator is responsible for ensuring that the height of the blocks remains acceptable.

The variation in height among blocks alters the volume, making it difficult to ascertain density even when the total weight of the blocks is known. Density is an important parameter affecting the long term durability of blocks, especially those used in high load applications such as roads. For most applications, the density must fall within a certain range.

Prior art methods of determining volume in order to calculate density are disclosed in such articles as Production control of concrete paving blocks, authored by Dr.-Ing Bernd Sagmeister and Dipl.-Ing Thomas Lenz. The article describes the importance of density to the properties of concrete blocks and describes a method of underwater weighing in order to calculate volume.

The invention provides a faster, easier and more accurate method of calculating volume in a method for determining density.

### SUMMARY OF THE INVENTION

A device for calculating the density of blocks includes a block manufacturing machine. In the block manufacturing machine, blocks are formed on a pallet. The weight of the empty pallet is known and the weight of the pallet after being loaded with blocks is measured. The length and width of each block is known form the block mold. However, the height of each block is measure, preferably by a laser height measuring station. From the known quantities, the volume and total weight of the blocks on the pallet are known. From these measurements, the density can be calculated to ensure that a minimum density of the blocks is maintained.

### BRIEF DESCRIPTION OF THE DRAWINGS

FIG. 1 depicts the three layers of a concrete block;

FIG. 2 is a perspective view of the apparatus for determining the density of blocks;

FIG. 3 is an isometric view of the weighing station; and

FIG. 4 is an end view of the lifter mechanism

### DETAILED DESCRIPTION OF THE INVENTION

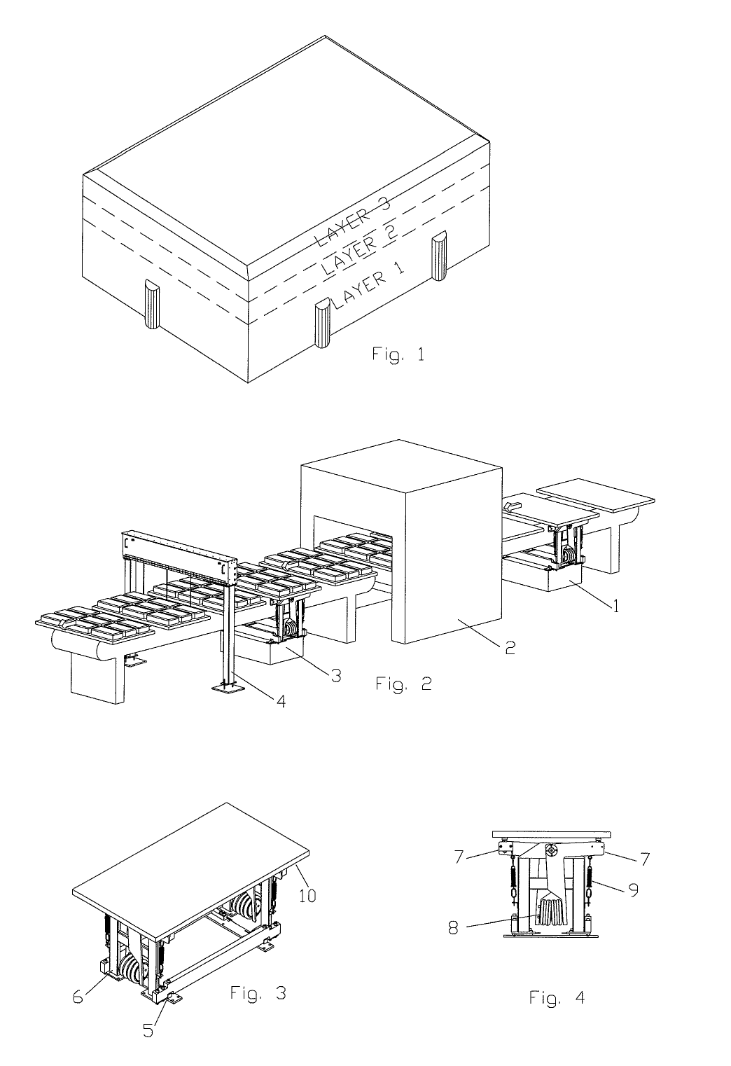

A block can be divided into three separate horizontal layers, as seen in FIG. 1. Blocks are typically formed with a two piece mold. The bottom mold forms the bottom part of the block having the spacers which protrude from the side but typically do not extend the entire height of the block. The top part of the mold fits within the bottom part and forms the chamfered top when the block has chamfers. The top mold sidewall overlaps the sidewall of the bottom wall but does not reach the bottom of the bottom mold. The variations of height between blocks are reflected in the distance between the top of the spacers and bottom of the chamfers. This results in two ways to calculate the volume of a block once the overall height is known. Since the length and width of the block are constant, being set by the mold, the volume can be calculated by multiplying the length and width by the measured height, then adding the volume added by the spacers and subtracting the volume lost because of the chamfers. The second method is to separate the block into three hypothetical layers. The bottom layer is at least as high as the spacers, possibly higher and the layer's volume is known and constant. The third layer extends downwardly from the top at least as much as the chamfer and its volume is also known and constant. It is only necessary that the height chosen for the first and third layer be less than the minimum overall height a block may ever have. The second layer is between the first and third and has a known length and width. The height is calculated by taking the measured overall height of the block and subtracting the height of the first and third layers. The volume of the second layer may be calculated and added to the known volumes of the first and third layer. As noted above, variations in height between blocks are reflected in the distance between the top of the spacers and the bottom of the chafer and so are reflected in the second layer. In summary:

Layer 1: Many blocks have spacers on some sides to aid in keeping a fixed space between successive blocks during their installation. These spacers may not run all the way from the bottom to the top, however their dimensions are known. Volume may be the simple product of area multiplied by the height of layer 1, or a more complex calculation. Layer 1 has a fixed volume.

Layer 2: This is the layer in the middle that has no spacers, nor chamfers. This layer's volume is calculated based on the area multiplied by the layer's height plus the area multiplied by plus or minus the laser measurement difference between nominal and actual height. Block height is an input from the laser measurement system, and is an average calculation determined from the individual block average heights.

Layer 3: The top layer, containing chamfers and possible a molded pattern. Volume may be the simple product of area times layer 1 height minus the chamfer's volume. This layer is also a fixed volume, and is known or calculated.

The total volume of the molded blocks must be known. This volume is the sum of the three layers multiplied by the number of blocks per pallet. Block weight is determined by the weighing system. Pre-weighing the pallets prior to being used in the mold machine is important as the empty pallets may vary considerably in weight due to dimensional variation, dry concrete buildup, and moisture content.

A preferred apparatus for carrying out the method according to the invention includes a weighing system for empty pallets, before the molding station, a weighing system for loaded pallets after the molding station and finally a laser height sensing system, all connected to a computer for determining and displaying block height, calculating and displaying density and the actual variation between desired block height and density.

Further details of the apparatus according to the invention are evident from the embodiment described below, by way of example, with reference to the accompanying drawings, wherein:

FIG. 2 is an isometric view showing, from right to left, the empty pallet weighing station 1, the block manufacturing machine 2, the loaded pallet weighing station 3, and the height measuring station 4. Pallets move from right to left on a conveyor.

When an empty pallet is conveyed to the empty pallet weighing station 1, its weight is recorded in memory. The pallet continues on a conveyor until it reaches the mold machine station 2, where the blocks are molded on the pallet. The loaded pallet then continues on another conveyor until it reaches the loaded pallet weighing station 3, where the weight is recorded in memory. At that time the empty pallet weight is subtracted from the loaded pallet weight. The loaded pallet then continues, passing under the laser height station, where height data is taken every 2 milliseconds, and stored in memory. When the lasers sense that the pallet has passed through the laser beams, the computer (not shown) uses the weight and height data to calculate and display the height, volume and density of the blocks on that pallet. The computer can calculate an average height for each block and, from this information, an average height for all blocks. There are typically several pallets between the empty pallet and the loaded pallet weighing stations. The weighing of the empty and loaded pallet must be accomplished during a time when no vibration is occurring in the mold machine.

FIG. 3 is an isometric view of the weighing station. One load sensor 5 is mounted from each corner of the weighing station to the floor. Each pallet 10 weighing station consists of two identical lifter mechanisms 6, one on each side of the conveyor and having two swivel arms 7.

FIG. 4 is an end view of the lifter mechanism. The swivel arms 7 are moveable by the expansion of a pneumatic bellows 8 by air pressure, which cause the pallet to be raised a short distance, during which the total weight of the pallet is sensed and recorded in the computer. After the weight is recorded the air pressure is vented from the pneumatic bellows, and they are allowed to contract, aided by spring 9 force, thus lowering the pallet back onto the conveyor.

I claim:

1. A system for calculating density of concrete blocks, comprising:
a block manufacturing machine forming at least one block;
a weighing station for determining the weight of the at least one block;
a height measuring station for determining the height of the at least one block; and
a computer receiving the weight of the at least one block, the computer determining the volume of the at least one block and calculating the density of the at least one block.

2. The system of claim 1, further comprising:
a conveyor extending between all stations.

3. The system of claim 1, wherein the height measuring station uses lasers to measure the height of each block.

4. The system of claim 1, wherein the weighing station comprises a first weighing station calculating the weight of an empty pallet; and
a second weighing station calculating the weight of the pallet having the at least one block.

5. The system of claim 1, wherein the computer determines an average height for the at least one block.

6. The system of claim 5, further comprising a plurality of blocks,
wherein the computer calculates an average height for each block and an average height for the plurality of blocks, the computer then calculating an average volume for the plurality of blocks.

7. The system of claim 2, wherein the height measuring station comprises lasers, the height measuring station being above the conveyor.

8. The system of claim 1, further comprising:
a conveyor extending between all stations;
a pallet, the pallet moved between the stations on the conveyor;
a plurality of blocks formed on the pallet by the block making machine;
the weighing station determining the weight of the plurality of blocks;
the height measuring station determining a height of each of the plurality of blocks; and
the computer calculating the average density of the plurality of blocks.

9. A method for calculating density of concrete blocks, comprising:
forming at least one block;
measuring the weight of the at least one block with a weighing station;
measuring the height of the at least one block with a height determining station;
determining the volume of the at least one block; and
calculating the density of the at least one block.

10. The method of claim 9, further comprising using a laser to measure the height of the at least one block.

11. The method of claim 9, further comprising:
forming a plurality of blocks; and
calculating an average height for each block and an average height of the plurality of blocks.

12. The method of claim 9, further comprising:
forming the at least one block on a pallet; and
moving the pallet between the stations.

13. The method of claim 12, further comprising
weighing the pallet before the at lest one block is formed on the pallet; and
weighing the pallet after the at lest one block is formed on the pallet to determine the weight of the at least one block.

14. The method of claim 13, wherein the at least one block is a plurality of blocks.
